(19) United States
(12) Patent Application Publication
(10) Pub. No.: US 2022/0326364 A1
(43) Pub. Date: Oct. 13, 2022

(54) METHOD FOR OPERATING A LIDAR SYSTEM

(71) Applicant: Robert Bosch GmbH, Stuttgart (DE)

(72) Inventor: Johannes Richter, Ludwigsburg (DE)

(21) Appl. No.: 17/713,808

(22) Filed: Apr. 5, 2022

(30) Foreign Application Priority Data
Apr. 8, 2021 (DE) 10 2021 203 464.0

(51) Int. Cl. G01S 7/497; G01S 7/481

(52) U.S. Cl. CPC G01S 7/497; G01S 7/4811

(57) ABSTRACT

A method for operating a LIDAR system. The LIDAR system includes multiple lasers, which are individually controllable and may emit laser light in different solid angles, and multiple detectors for detecting laser light. The method includes: first emission of laser light by the multiple lasers using a predefined first power in each case at different solid angles in each case; reception of reflected laser light by the detectors; establishing that at least one first detector exceeds a predefined first intensity level and/or has entered saturation; second emission of laser light by the multiple lasers, the laser power of at least one first laser, which is assigned to the first detector exceeding the first intensity level and/or entering saturation, being reduced. A corresponding LIDAR system, a corresponding computer program, and a corresponding machine-readable memory medium are also described.

### FIELD

The present invention is directed to a method for operating a LIDAR system.

### BACKGROUND INFORMATION

Highly and fully automated vehicles (level 3-5) will be encountered more and more on our roads in the upcoming years. In particular LIDAR systems play an increasingly important role for autonomous driving systems.

The high point rates required by LIDAR systems make it necessary to measure multiple measuring points simultaneously—this is referred to as parallelization of the measurements. The scene to be measured may be illuminated using a vertical laser stripe and imaged in the receiving path on a vertical detector array, for example, so that each detector pixel covers one measuring point in the space. The measurement time is greatly shortened by such parallelization, since a complete column of points is measured simultaneously. However, the LIDAR system is also more strongly susceptible to crosstalk of the optical signal within a column (also called blooming). This crosstalk is particularly strong for highly reflective targets, for example, retroreflective targets (for example, traffic signs), which, under certain circumstances, may also trigger other measuring points of the column. In such a case, the object to be measured appears greatly enlarged in the point cloud and, under certain circumstances, may even obscure the entire vertical field of view. In this case, the LIDAR system would be blind in certain areas (for example, below a retroreflective sign gantry). It is therefore necessary to develop LIDAR architectures which enable a high degree of parallelization but prevent blooming at the same time.

### SUMMARY

A method is described for operating a LIDAR system in accordance with the presention.

The LIDAR system includes multiple lasers, which are individually controllable and may emit laser light in different solid angles, and multiple detectors for detecting laser light.

In accordance with an example embodimetn of the presnet invention, a first emission of laser light is carried out by the multiple lasers using a predefined first power in different solid angles in each case.

Laser light that is reflected by objects in the propagation path of the laser light is received by the detectors.

It is subsequently established that at least one first detector exceeds a predefined first intensity level and/or has entered saturation.

A second emission of laser light is then carried out by the multiple lasers, the laser power of at least a first laser, which is assigned to first detector 45, which has exceeded the first intensity level and/or has entered saturation, being reduced. The assignment of the laser-detector is static, that means it takes place once. This may either be carried out “by design,” since it is known on the basis of the optical design of the sensor which laser is imaged on which detector.

Alternatively, this assignment may also be determined in a calibration step at the end of the manufacture and stored in the sensor. There are multiple options for reducing the laser power. The laser power may either be reduced to 0 or reduced in accordance with the measured intensity in the detector. A constant factor is also conceivable, for example, a factor of 10,000, because retroreflectors are usually similarly bright.

This is advantageous since the so-called “blooming effect,” crosstalk of the optical signal between the detectors or detector pixels, is thus reduced. At the same time, the sensor advantageously maintains the full range in all other detector pixels. Furthermore, the dynamic scope of the detector is increased by this method, since the brightness of the retroreflector may be accurately determined. Optionally, the power in the other pixels may also be increased at the same time and thus a range increase may be achieved in these pixels. This is possible since due to the power reduction, the power is now farther below the eye safety limit.

Further advantageous specific example embodiments of the present invention are disclosed herein.

Laser light, this time the laser light emitted during the second emission, which is again reflected by objects in the propagation path of the laser light, is advantageously again received by the detectors.

It is established again that at least one second detector has exceeded a predefined second intensity level and/or has entered saturation.

Subsequently, a third emission of laser light is carried out by the multiple lasers, the laser power of at least one second laser, which is assigned to the detector exceeding the intensity level and/or entering saturation, being reduced further in comparison to the second emission. This is advantageous to further reduce the “blooming effect” and thus also be able to detect strongly reflecting objects correctly by way of the LIDAR system.

The lasers advantageously emit laser light at full power during the first emission. This is advantageous to achieve a maximum range of the LIDAR system.

Furthermore, the subject matter of the present invention is a LIDAR system which includes multiple lasers, which are individually controllable and may emit in different solid angles, and multiple detectors for detecting laser light and an electronic control unit, which are configured to carry out the steps of the method according to the present invention. This is advantageous since the LIDAR system has a reduced influence of the so-called “blooming effect,” a reduced crosstalk of the optical signal between the detectors or detector pixels.

The lasers and/or the detectors are advantageously designed as a vertical array or as a horizontal array. This is advantageous to achieve parallelization and thus shortening of the measurement time of the LIDAR system. At the same time, the costs of a 1D array are lower than those of a 2D array.

The lasers and/or the detectors are advantageously designed as a 2D array. This is advantageous to reduce the measurement time of the LIDAR system still further, since one measuring procedure of the LIDAR system is sufficient in this case to be able to detect objects in the measuring range of the LIDAR system and determine their distance.

The number of columns of detectors is advantageously greater than or equal to the number of columns of lasers and/or the number of lines of detectors is greater than or equal to the number of lines of lasers. This is advantageous to ensure a cost-effective implementation of the LIDAR system. This simplifies the activation of the laser diodes.

The detectors are advantageously each designed as detector pixels of a detector array and/or the lasers are each designed as part of a laser array. This is advantageous to achieve a simple implementation of the LIDAR system, since no individual detectors or lasers are thus required, but rather they may be manufactured as part of a composite or array. Furthermore, the alignment and the angle calibration of the detectors is simplified due to the arrangement in an array.

Furthermore, the subject matter of the present invention is a computer program, including commands which effectuate that the LIDAR system according to the present invention carries out the method according to the present invention. The mentioned advantages may thus be achieved.

Furthermore, the subject matter of the present invention is a machine-readable memory medium, on which the above-mentioned computer program is stored. The mentioned advantages may thus be achieved.

### BRIEF DESCRIPTION OF THE DRAWINGS

Advantageous specific embodiments of the present invention are shown in the figures and explained in greater detail in the following description.

FIG. 1 shows a flowchart of the method according to the present invention according to one specific example embodiment of the present invention.

FIG. 2 shows a first schematic representation of carrying out the method according to one specific example embodiment of the present invention.

FIG. 3 shows a second schematic representation of carrying out the method according to the specific example embodiment of the present invention.

FIG. 4 shows a schematic representation of the LIDAR system according to the present invention according to one specific example embodiment of the present invention.

### DETAILED DESCRIPTION OF EXAMPLE EMBODIMENT

Identical reference numerals identify identical device components or identical method steps in all figures.

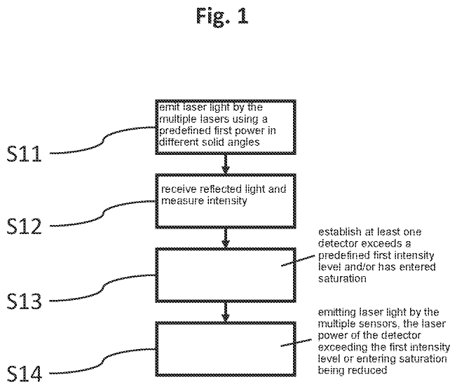

FIG. 1 shows a flowchart of the method according to the present invention for operating a LIDAR system according to one specific embodiment. The LIDAR system includes multiple lasers, which are individually controllable and may emit laser light in different solid angles. Furthermore, the LIDAR system includes multiple detectors for detecting laser light.

In a first step S11, laser light is first emitted by each of the multiple lasers using a predefined first power in different solid angles in each case.

In a second step S12, the laser light, which is reflected, for example, by objects in the field of view of the LIDAR system, is received by the detectors of the LIDAR system, that means registered, and the intensity is measured, for example.

In a third step S13, it is established that at least one first detector exceeds a predefined first intensity level and/or has entered saturation.

In a fourth step S14, laser light is emitted by the multiple lasers a second time, the laser power of at least one first laser, which is assigned to the first detector exceeding the first intensity level and/or entering saturation, is reduced.

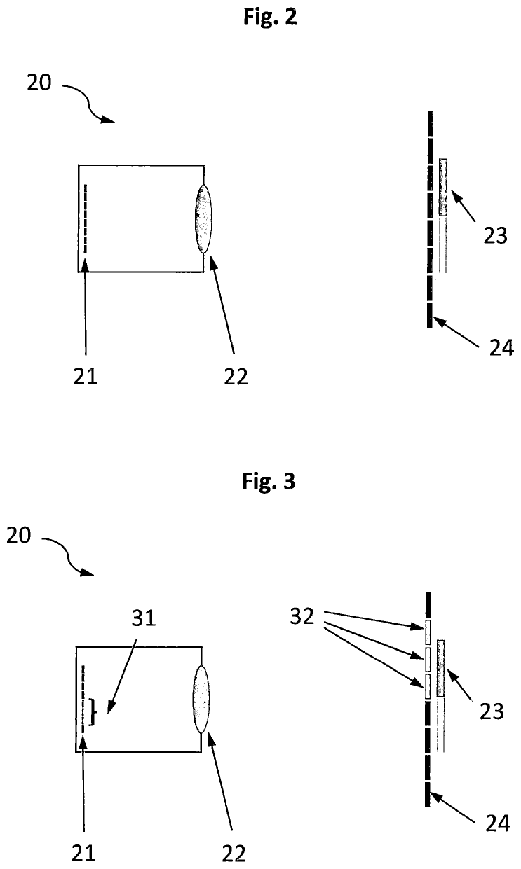

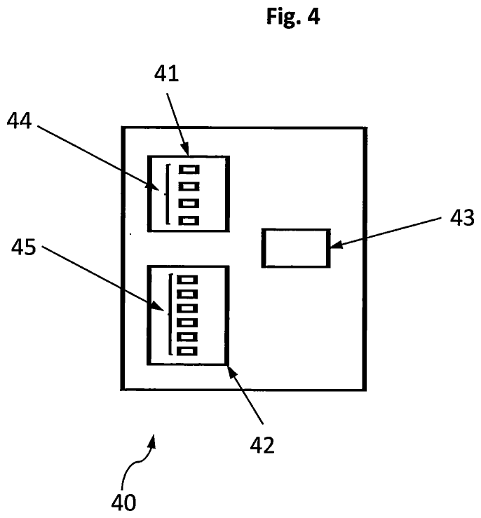

The method is illustrated in FIGS. 2 and 3.

FIG. 2 shows a first schematic representation of carrying out the method according to one specific embodiment.

A LIDAR system 20 emits a laser stripe 24 at full power with the aid of a laser array 21. Laser array 21 may individually regulate the power of each individually emitted laser beam. As is apparent from FIG. 2, the laser light is emitted in different solid angles in each case. This is ensured by objective 22.

In the far field, laser stripe 24 expands accordingly. As soon as the laser light is incident on a retroreflector 23, a portion of the laser light is reflected by retroreflector 23 and received or registered by detectors (not shown here) of LIDAR system 20.

FIG. 3 shows a second schematic representation of carrying out the method according to the specific embodiment. It was established that detectors exceed a predefined first intensity level. In corresponding assigned first laser 31, the assignment between lasers and detectors being able to take place as stated above, the laser power is reduced in each case and laser array 21 emits laser light a second time, first laser 31 doing this at the particular correspondingly reduced power.

Therefore, only laser light 32 at reduced power is also incident on retroreflector 23, which prevents saturation of the corresponding detectors upon renewed reception of laser light 32, which is reflected again.

FIG. 4 shows a schematic representation of LIDAR system 40 according to the present invention according to one specific embodiment. LIDAR system 40 includes a laser array 41 including multiple lasers 44 and a detector array 42 including multiple detector pixels 45. Furthermore, system 40 includes an electronic control unit 43, which, for example, carries out a corresponding establishment of the saturation of a detector pixel 45 and, for example, controls the method sequence. Electronic control unit 43 may be connected, for example, with the aid of communication lines to laser array 41 and detector array 42.

1-10. (canceled)

11. A method for operating a LIDAR system, the LIDAR system including multiple lasers which are individually controllable and may emit laser light in different solid angles, and multiple detectors configured to detect laser light, the method comprising the following steps:
a) first emitting of laser light by the multiple lasers using a predefined first power in each case in different solid angles in each case;
b) receiving reflected laser light by the detectors;
c) establishing that at least one first detector exceeds a predefined first intensity level and/or has entered saturation;
d) second emitting of laser light by the multiple lasers, laser power of at least one first laser which is assigned to the first detector that exceeded the first intensity level and/or entered saturation, being reduced for the second emitting.

12. The method as recited in claim 11, further comprising:
e) renewed receiving of reflected laser light by the detectors;
f) renewed establishing that at least one second detector exceeds a predefined second intensity level and/or has entered saturation;
g) third emitting of laser light by the multiple lasers, laser power of at least one second laser, which is assigned to the second detector that exceeded the second intensity level and/or entered saturation, being reduced for the third emitting.

13. The method as recited in claim 11, wherein in step a) the multiple lasers each emit laser light at full power.

14. A LIDAR system, comprising:
multiple lasers which are individually controllable and may emit in different solid angles;
multiple detectors configured to detect laser light; and
an electronic control unit configured to:
control the multiple lasers for a first emission of laser light using a predefined first power in each case in different solid angles in each case, reflected laser light being received by the detectors;
establish that at least one first detector exceeds a predefined first intensity level and/or has entered saturation;
control the multiple lasers for a second emission of laser light, laser power of at least one first laser which is assigned to the first detector that exceeded the first intensity level and/or entered saturation, being reduced for the second emission.

15. The LIDAR system as recited in claim 14, wherein the lasers and/or the detectors configured as a vertical array or as a horizontal array.

16. The LIDAR system as recited in claim 14, wherein the lasers and/or the detectors are configred as a 2D array.

17. The LIDAR system as recited in claim 16, wherein a number of columns of the detectors is greater than or equal to a number of columns of lasers and/or a number of lines of detectors is greater than or equal to a number of lines of lasers.

18. The LIDAR system as recited in claim 14, wherein the detectors are each configured as detector pixels of a detector array and/or the lasers are each configured as part of a laser array.

19. A non-transitory machine-readable memory medium on which is stored a computer program for operating a LIDAR system, the LIDAR system including multiple lasers which are individually controllable and may emit laser light in different solid angles, and multiple detectors configured to detect laser light, the computer program, when executed by a computer, causing the computer to perform the following steps:
a) first emitting of laser light by the multiple lasers using a predefined first power in each case in different solid angles in each case;
b) receiving reflected laser light by the detectors;
c) establishing that at least one first detector exceeds a predefined first intensity level and/or has entered saturation; and
d) second emitting of laser light by the multiple lasers, laser power of at least one first laser which is assigned to the first detector that exceeded the first intensity level and/or entered saturation, being reduced for the second emitting.
